(19) United States
(12) Patent Application Publication
(10) Pub. No.: US 2006/0231227 A1
(43) Pub. Date: Oct. 19, 2006

(54) Paper and paper articles and method for making same

(76) Inventors: Richard C. Williams, Middletown, NY (US); Peter M. Froass, Chester, NY (US)

Correspondence Address: INTERNATIONAL PAPER COMPANY, 6285 TRI-RIDGE BOULEVARD, LOVELAND, OH, 45140, US

(21) Appl. No.: 10/437,856

(22) Filed: May 14, 2003

Related U.S. Application Data
(63) Continuation-in-part of application No. 10/121,301, filed on Apr. 11, 2002, now Pat. No. 6,866,906.
Application No. 10/121,301 is a continuation-in-part of application No. 09/770,340, filed on Jan. 26, 2001, now Pat. No. 6,802,938.
(60) Provisional application No. 60/178,214, filed on Jan. 26, 2000.

(51) Int. Cl. D21H 17/00; B32B 27/00

(52) U.S. Cl. 162/158; 162/205; 162/135; 162/164.1; 162/169; 428/340

(57) ABSTRACT

This invention relates to a paper material containing cellulosic fibers and from about 0.1 to about 6.0 wt % by weight dry basis expandable microspheres and a density of at least about 6.0 lb/3000 ft²/mil and articles formed there from such as file folders.

### RELATED APPLICATIONS

This application is a continuation-in-part of co-pending application Ser. No. 10/121,301, filed Apr. 11, 2002, which is a continuation-in-part of co-pending application Ser. No. 09/770,340 filed Jan. 26, 2001, which is a continuation-in-part of provisional application Ser. No. 60/178,214, filed Jan. 26, 2000. This application also claims the benefit of provisional application Ser. No. 60/282,983, filed Apr. 11, 2001.

### BACKGROUND

1. Field of the Invention

The invention relates to the papermaking arts and, in particular, to the manufacture of paper and paperboard substrates. This invention also relates to articles of manufacture manufactured from the substrates of this invention such as printing paper, forms paper and file folders.

2. Background of the Invention

The contemporary work office uses a myriad of paper products including, but not limited to, writing papers, printing paper, copy paper, forms paper, notepads, and file folders and/or jackets to organize and store various paperwork. Unfortunately, such paper products exhibit one or more disadvantages. For example, some of these products having relatively low basis weights are not sufficiently stiff and durable to protect the contents of the file and to stand upright or remain relatively flat and self-supporting. Other products which have fold lines for opening and closing the product, as for example a file folder or jacket, are not sufficiently strong at the fold line to stand up to the repeated opening and closing. Still other of such products also typically have edges which have a tendency to inflict so called “paper cuts” upon personnel handling the files. While rarely presenting a case of serious injury, paper cuts are nonetheless an inconvenience and may cause considerable discomfort as such cuts are often jagged and irregular and formed across the highly sensitive nerve endings of the fingers.

Accordingly, there exists a need for improved paper products which reduce or eliminate one or more of these disadvantages.

### SUMMARY OF THE INVENTION

With regard to the foregoing and other objects and advantages, the present invention provides a method for making a paper or paperboard substrate having one or more improved properties such as enhanced GM Fold, enhanced GM Taber Stiffness and/or a reduced tendency to cut human skin and tissue. The method includes (i) providing a papermaking furnish including cellulosic fibers, expanded or expandable microspheres (preferably from about 0.1 to about 6 wt % by weight dry basis) and, optionally, conventional furnish additives including fillers, retention aids, and the like, (ii) forming a fibrous web from the papermaking furnish and (iii) dry*ing the web to form a dried web. In the preferred embodiments of the invention, the method also comprise calendering the web as for example to a caliper of from about 3 to about 25 mils preferably using a reduced calendering pressure of less than about 350 lbs/lineal inch.

In another aspect, the invention relates to a paper or paperboard substrates for use in the manufacture of paper articles such as file folders, envelope paper, printing and publication paper and paperboard substrates for the fabrication of cartons. The paper or paperboard substrate includes a paper or paperboard web comprising cellulosic fibers and expanded microspheres (preferably from about 0.1 to about 5 wt % by wgt (dry basis)) dispersed within the fibers and, optionally, conventional paper additives including one or more fillers and starches. Surprisingly, it has been discovered that these substrates exhibit one or more enhanced properties as compared to a substrate that is the same except that it does not include the expanded microspheres. For example, applicants have discovered that for some embodiments of this invention, the substrate exhibits improved Sheffield Smoothness (TAPPI 538om-88) or Parker Print Surf (TAPPI 555om-99) on both wire side and felt side of the substrate as compared to the same substrate which does not include microspheres. Applicants have also discovered that the substrate exhibits enhanced GM Fold as compared to the same substrate which does not include microspheres. It has also been surprisingly discovered that this enhancement in GM Fold increases with increasing density and that those embodiments of the invention in which the density is equal to or greater than about 6 lbs/3000 ft²/mil, preferably equal to or greater than about 7 lbs/3000 ft²/mil, more preferably from about 7 lbs/3000 ft²/mil to about 13 lbs/3000 ft²/mil and most preferably from about 8.5 lbs/3000 ft²/mil to about 11 lbs/3000 ft²/mil are preferred. The embodiments of the invention having enhanced GM Fold are especially useful in the manufacture of paper and paperboard based products where these properties are useful and desirable such as in the manufacture of such products having a fold or score line where there may be flexing or folding along the line such as file folders and juice cartons.

Surprisingly, applicants have also discovered that the substrate exhibits enhanced GM Taber Stiffness if calendered in a calendering apparatus having one or more nips, as for example steel to steel, steel to soft, soft to soft, shoe nip, belt and other calendering apparatus where calendering pressure in any nip is not greater than about 350 lbs/lineal inch.

The improved GM Taber Stiffness makes the paper or paperboard substrate of this invention especially useful in the manufacture of paper and paperboard substrates where improved stiffness is desirable as for example lower basis weight products having a basis weight of less than about 300 lbs/3000 ft², preferably less than about 200 lbs/3000 ft², more preferably less than about 180 lbs/3000 ft² and most preferably from about 20 to about 150 lbs/3000 ft² such as printing paper, forms paper, publication papers and envelope paper.

Surprisingly, it has also been discovered that certain embodiments of this invention having a density of from about 6 to about 13 lb/3000 ft²/mil and a caliper of from about 3 to about 25 mils exhibit an improved resistance to inflicting cuts upon human skin. These embodiments of the invention are useful in the fabrication of paper and paperboard products in which improved resistance to inflicting cuts upon the human skin is desirable.

In another aspect, this invention relates to articles of manufacture prepared from the paper or paperboard substrate of this invention that are designed to take advantages of the beneficial properties of the paper and paperboard substrate of this invention. Such articles of manufacture include paper or paperboard products having at least two substantially planar portions joined at a fold line where the portions are designed to flex along the line such as a file folder or jacket. The file folder or jacket type product comprises a paper web including wood fibers and expanded microspheres dispersed within the fibers. The paper web has a density of from about 6 to about 18 lb/3000 ft²/mil and a caliper of from about 3 to about 25 mils. The paper web is die cut to provide exposed edges on the folder or jacket that exhibit improved resistance to inflicting cuts upon human skin. The products also exhibits enhanced GM Fold and GM Taber Stiffness if calendered at a calendering pressure equal to or less than about 350 lbs/lineal inch. Such articles of manufacture also include lower basis weight products in which the basis weight is equal to or less than 200 lbs/3000 ft² such as printing paper, copy paper, writing paper, envelope paper and forms paper in cut size and roll form which exhibit relatively enhanced GM Taber Stiffness even though they have relatively low basis weights.

In accordance with one preferred embodiment of the invention, the paper web has a density of from about 6 lb/3000 ft²/mil to about 11 lb/3000 ft²/mil., more preferably from about 6 lb/3000 ft²/mil to about 9 lb/3000 ft²/mil and most preferably density of from about 6 lb/3000 ft²/mil to about 8 lb/3000 ft²/mil. It is also preferred that the paper web have a caliper of about 14.0 to about 16.0 mils. The basis weight of the web is typically from about 80 lb/3000 ft² to about 300 lb/3000 ft², more preferably from about 120 lb/3000 ft² to about 150 lb/3000 ft².

Typically the microspheres in the paper web comprise synthetic polymeric microspheres and comprise from about 0.1 to about 6.0 wt % of the total weight of the web on a dry basis. The web preferably compresses from about 0.25 to about 5.0 wt %, more preferably from about 0.5 to about 4.0 wt %, and most preferably from about 0.5 to about 3.0 wt % on the aforementioned basis. It is particularly preferred that the microspheres comprise microspheres made from a polymeric material selected from the group consisting of methyl methacrylate, ortho-chlorostyrene, polyortho-chlorostyrene, polyvinylbenzyl chloride, acrylonitrile, vinylidene chloride, para-tert-butyl styrene, vinyl acetate, butyl acrylate, styrene, methacrylic acid, vinylbenzyl chloride and combinations of two or more of the foregoing. The microspheres have a preferred expanded diameter of from about 30 to about 60 microns.

In addition, it may be preferred in some cases to initially disperse the

microspheres in the furnish in an unexpanded state and subsequently expand

the microspheres as the paper web dries.

The cellulosic fibers of the web may be provided from hardwoods, softwoods, or a mixture of the two. Preferably, the fibers in the paper web include from about 30% to about 100% by weight dry basis softwood fibers and from about 70% to about 0% by weight dry basis hardwood fibers.

### BRIEF DESCRIPTION OF THE DRAWINGS

The above and other aspects and advantages of the invention will now be further described in conjunction with the accompanying drawings in which:

FIG. 1 is photomicrograph illustrating edges of conventional papers after being cut by various paper cutting techniques;

FIG. 2 is another photomicrograph comparing a die cut conventional paper and a die cut paper according to one embodiment of the present invention;

FIG. 3 is a side elevational view illustrating diagrammatically a paper die cutting apparatus for use in reverse die cutting paper samples;

FIG. 4 is a side elevational view illustrating diagrammatically a testing apparatus for simulating paper cuts upon a finger;

FIG. 5 is a perspective view illustrating certain aspects of the testing apparatus of FIG. 4.

FIG. 6 is a plot of GM Fold versus density for substrates having a basis weight of 90 lbs/3000 ft² with and without microspheres.

FIG. 7 is a plot of GM Fold versus density for substrates having a basis weight of 100 lbs/3000 ft² with and without microspheres.

FIG. 8 is a plot of GM Fold versus density for substrates having a basis weight of 118 lbs/3000 ft² with and without microspheres.

FIG. 9 is a plot of GM Taber Stiffness versus calendering pressure for substrates having a basis weight of 90 lbs/3000 ft² with and without microspheres.

FIG. 10 is a plot of GM Taber Stiffness versus calendering pressure for substrates having a basis weight of 100 lbs/3000 ft² with and without microspheres.

FIG. 11 is a plot of GM Taber Stiffness versus calendering pressure for substrates having a basis weight of 118 lbs/3000 ft² with and without microspheres.

FIG. 12 is a plot of GM Taber Stiffness versus basis weight for substrates calendered to different pressures with and without microspheres.

FIG. 13 is a plot of wire side Sheffield Smoothness versus density for substrates having a basis weight of 90 lbs/3000 ft² with and without microspheres.

FIG. 14 is a plot of wire side Sheffield Smoothness versus density for substrates having a basis weight of 100 lbs/3000 ft² with and without microspheres.

FIG. 15 is a plot of wire side Sheffield Smoothness versus density for substrates having a basis weight of 118 lbs/3000 ft² with and without microspheres.

FIG. 16 is a plot of wire side Parker Print Surf versus density for substrates having a basis weight of 90 lbs/3000 ft² with and without microspheres.

FIG. 17 is a plot of wire side Parker Print Surf versus density for substrates having a basis weight of 100 lbs/3000 ft² with and without microspheres.

FIG. 18 is a plot of wire side Parker Print Surf versus density for substrates having a basis weight of 118 lbs/3000 ft² with and without microspheres.

FIG. 19 is a plot of felt side Sheffield Smoothness versus density for substrates having a basis weight of 90 lbs/3000 ft² with and without microspheres.

FIG. 20 is a plot of felt side Sheffield Smoothness versus density for substrates having a basis weight of 100 lbs/3000 ft² with and without microspheres.

FIG. 21 is a plot of felt side Sheffield Smoothness versus density for substrates having a basis weight of 118 lbs/3000 ft² with and without microspheres.

FIG. 22 is a plot of felt side Parker Print Surf versus density for substrates having a basis weight of 90 lbs/3000 ft² with and without microspheres.

FIG. 23 is a plot of felt side Parker Print Surf versus density for substrates having a basis weight of 100 lbs/3000 ft² with and without microspheres.

FIG. 24 is a plot of felt side Parker Print Surf versus density for substrates having a basis weight of 118 lbs/3000 ft² with and without microspheres.

FIG. 25 is a plot of GM Fold versus basis weight for substrates with and without micro spheres.

### DETAILED DESCRIPTION OF THE INVENTION

One aspect of this invention is directed to a paper material having improved cut resistance, i.e., the edges of the paper have a reduced tendency to cut, abrade, or damage human skin. This invention also relates to a paper material having improved GM Taber Stiffness and improved GM Fold. As used herein, “paper” refers to and includes both paper and paperboard unless otherwise noted.

The paper is provided as a web containing cellulosic pulp fibers such as fiber derived from hardwood trees, softwood trees, or a combination of hardwood and softwood trees prepared for use in a papermaking furnish by any known suitable digestion, refining, and bleaching operations. In a preferred embodiment, the cellulosic fibers in the paper include from about 30% to about 100% by weight dry basis softwood fibers and from about 70% to about 0% by weight dry basis hardwood fibers. In certain embodiments, at least a portion of the fibers may be provided from non-woody herbaceous plants including, but not limited to, kenaf, hemp, jute, flax, sisal, or abaca although legal restrictions and other considerations may make the utilization of hemp and other fiber sources impractical or impossible.

In addition to pulp fibers, the paper material also includes dispersed within the fibers from about 0.1 to about 6.0 wt % by dry weight expanded or unexpanded microspheres. Preferably the paper includes from about 0.25 to about 5.0 wt % expanded or unexpanded microspheres, more preferably the paper includes from about 0.5 to about 4.0 wt % expanded or unexpanded microspheres and most preferably the paper includes from about 0.5 to about 3.0 wt % expanded or unexpanded microspheres.

Expanded and expandable microspheres are well known in the art. For example, suitable expandable microspheres are described in co-pending application Ser. No. 09/770,340 filed Jan. 26, 2001 and Ser. No. 10/121,301, filed Apr. 11, 2002; U.S. Pat. Nos. 3,556,934, 5,514,429, 5,125,996, 3,533,908, 3,293,114, 4,483,889, and 4,133,688; and UK Patent Application 2307487, the contents of which are incorporated by reference. All conventional microspheres can be used in the practice of this invention. Suitable microspheres include synthetic resinous particles having a generally spherical liquid-containing center. The resinous particles may be made from methyl methacrylate, ortho-chlorostyrene, polyortho-chlorostyrene, polyvinylbenzyl chloride, acrylonitrile, vinylidene chloride, para-tert-butyl styrene, vinyl acetate, butyl acrylate, styrene, methacrylic acid, vinylbenzyl chloride and combinations of two or more of the foregoing. Preferred resinous particles comprise a polymer containing from about 65 to about 90 percent by weight vinylidene chloride, preferably from about 65 to about 75 percent by weight vinylidene chloride, and from about 35 to about 10 percent by weight acrylonitrile, preferably from about 25 to about 35 percent by weight acrylonitrile.

The microspheres preferably subsist in the paper web in an “expanded” state, having undergone expansion in diameter preferably in the order of from about 300 to about 600% from an “unexpanded” state in the original papermaking furnish from which the web is derived. In their original unexpanded state, the center of the expandable microspheres may include a volatile fluid foaming agent to promote and maintain the desired volumetric expansion. Preferably, the agent is not a solvent for the polymer resin. A particularly preferred foaming agent is isobutene, which may be present in an amount ranging from about 10 to about 25 percent by weight of the total weight of the resinous particles. Upon heating to a temperature in the range of from about 80° C. to about 190° C. as for example in the dryer unit of a papermaking machine, the resinous particles expand to a diameter of up to about 60 microns, preferably ranging from about 30 to about 60 microns. Suitable expandable microspheres are available from Akzo Nobel of Marietta, Ga. under the trade name EXPANCEL. Expandable microspheres and their usage in paper materials are described in more detail in co-pending application Ser. No. 09/770,340 filed Jan. 26, 2001 and co-pending application Ser. No. 10/121,301, filed Apr. 11, 2002, the contents of which are incorporated by reference.

The web may also include other conventional additives such as, for example, starch, fillers, sizing agents, retention aids, and strengthening polymers. Among the fillers that may be used are organic and inorganic pigments such as, by way of example, polymeric particles such as polystyrene latexes and polymethylmethacrylate, and minerals such as calcium carbonate, barium sulfate, mica, kaolin and talc. Other conventional additives include, but are not restricted to, wet strength resins, internal sizes, dry strength resins, alum, fillers, pigments and dyes. For obtaining the highest levels of surface sizing in the processes of this invention, it is preferred that the sheet be internally sized, that is, that sizing agents be added to the pulp suspension before it is converted to a paper web or substrate. Internal sizing helps prevent the surface size from soaking into the sheet, thus allowing it to remain on the surface where it has maximum effectiveness. The internal sizing agents encompass any of those commonly used at the wet end of a paper machine. These include rosin sizes, ketene dimers and multimers, and alkenylsuccinic anhydrides. The internal sizes are generally used at concentration levels known to art as for examples at levels of from about 0.05 wt. % to about 0.25 wt. % based on the weight of the dry paper sheet. Methods and materials utilized for internal sizing with rosin are discussed by E. Strazdins in The Sizing of Paper, Second Edition, edited by W. F. Reynolds, TAPPI Press, 1989, pages 1-33. Suitable ketene dimers for internal sizing are disclosed in U.S. Pat. No. 4,279,794, which is incorporated by reference in its entirety, and in United Kingdom Patent Nos. 786,543; 903,416; 1,373,788 and 1,533, 434, and in European Patent Application Publication No. 0666368 A3. Ketene dimers are commercially available, as Aquapel.RTM. and Precis.RTM. sizing agents from Hercules Incorporated, Wilmington, Del. Ketene multimers for use in internal sizes are described in European Patent Application Publication No. 0629741A1, corresponding to U.S. patent application Ser. No. 08/254,813, filed Jun. 6, 1994; European Patent Application Publication No. 0666368A3, corresponding to U.S. patent application Ser. No. 08/192,570, filed Feb. 7, 1994; and U.S. patent application Ser. No. 08/601,113, filed Feb. 16, 1996. Alkenylsuccinic anhydrides for internal sizing are disclosed in U.S. Pat. No. 4,040,900, which in incorporated herein by reference in its entirety, and by C. E. Farley and R. B. Wasser in The Sizing of Paper, Second Edition, edited by W. F. Reynolds, TAPPI Press, 1989, pages 51-62. A variety of alkenylsuccinic anhydrides are commercially available from Albemarle Corporation, Baton Rouge, La.

The caliper of the paper of the present invention may vary widely. Papers formed according to the present invention preferably have a final caliper, after calendering of the paper, and any nipping or pressing such as may be associated with subsequent coating as high as about 3 mils and as low as about 25 mils, depending on the use of the paper material. Applicants have discovered that paper material of the invention which exhibits resistance to inflicting cuts on human skin exhibited a caliper of from about 7.0 to about 18.0 mils, preferably from about 8.0 to about 14.0 mils, more preferably from about 9 to about 12 mils, and most preferably from about 10.0 to about 11.5 mils.

The basis weight of the paper of this invention may also vary widely depending on the uses of the paper material. The paper material preferably exhibits a basis weight of from about 20 lb/3000 ft² to about 300 lb/3000 ft², more preferably from about 20 lb/3000 ft² to about 200 lb/3000 ft², and most preferably from 30 lb/3000 ft² to about 180 lb/3000 ft². Applicants have surprisingly discovered that the difference in GM Fold between the paper material of this invention and the same paper material except that it does not include Microspheres increases with increasing basis weight. In these embodiments where enhanced GM Fold is desirable, to achieve the greatest difference in GM Fold the basis weight should be 90 lbs/3000 ft² or greater. In these embodiments, the basis weight is preferably equal to or greater than about 100 lbs/3000 ft² and more preferably equal to or greater than 105 lbs/3000 ft².

The GM Taber Stiffness of the paper material of this invention may vary widely. Surprisingly, applicants have discovered that the GM Taber Stiffness of the paper material of this invention is higher than that of the same paper material excluding the microspheres where the substrate of this invention is calendered at a pressure equal to or less than about 350 lbs per lineal inch. Because of the enhanced GM Taber Stiffness of the paper material, lower basis weight materials of this invention containing the expanded microspheres can be used in applications where paper materials which do not include microspheres and having higher basis weights are used. For example, this paper material of this invention exhibits GM Taber Stiffness comparable to that of the same material except that the basis weight is up to 5 or 10% and was not calendered at reduced pressures.

The GM Fold of the paper material of this invention may vary widely but is also higher than that of the same paper material which does not include microspheres. In general, experimentation has shown that in the present invention, the GM Fold increases with increasing density. The GM Fold is preferably at least 200 and is more preferably at least about 350.

The density of the paper material is at least about 6 lbs/3000 ft²/mil. As shown by experimentation, applicants have shown that improvement in GM Fold of the paper material of this invention as compared to that of the same material which does not include the microspheres increases with increasing density. Accordingly, higher densities, preferably, equal 7.0 lb/3000 ft² are preferred where higher GM Fold is desired. In these preferred embodiments, the final density of the papers, that is, the basis weight divided by the caliper, is typically from about 7.0 lb/3000 ft²/mil to about 12.0 lb/3000 ft²/mil, preferably from about 7.5 lb/3000 ft²/mil to about 9.0 lb/3000 ft²/mil more preferably from about 7.5 lb/3000 ft²/mil to about 9.0 lb/3000 ft²/mil and most preferably from about 7.5 lb/3000 ft²/mil to about 9.0 lb/3000 ft²/mil. Thus, the paper has a relatively larger caliper in relation to its weight compared to conventional papers. The reduction in basis weight versus caliper is believed to be attributable at least in part to the large number of tiny voids in the paper associated with the expanded microspheres interspersed in the fibers with the microspheres causing, especially during the expansion process, a significant increase in the void volume in the material. In addition, the paper after drying operations is calendered sufficient to achieve the final desired calipers discussed herein along with any desired surface conditioning of the web associated with the calendering operation. The impartation of a significantly increased void volume along with a relatively high caliper also has the effect of reducing the density of the paper while retaining good stiffness and other properties important for use as stock for file folders and the like.

Methods and apparatuses for preparing a paper or paperboard substrate are well known in the paper and paperboard art. See for example “Handbook For Pulp & Paper Technologies”, 2^{nd} Edition, G. A. Smook, Angus Wilde Publications (1992) and references cited therein. Any conventional method and apparatus can be used.

Preferably the process comprises: a) providing an aqueous pulp suspension; b) sheeting and drying the aqueous pulp suspension to obtain dried paper or paperboard web; c) drying the paper to obtain dried paper or paperboard web and d) calendering the dried paper or paper board web. In addition to these process steps, additional process steps known to those of ordinary skill in the art may be employed as for example a coating step to coat one or more surfaces of the web with a coating comprising a binder containing dispersant pigment.

In step a) of the preferred embodiment of this invention, an aqueous pulp suspension is formed. Methods and apparatus of forming aqueous pulp are well known in the paper and paperboard art and will not be described in any great detail. See for example G. A. Smook referenced above and references cited therein. Any conventional aqueous pulp suspension forming method can be used. The cellulosic fibrous component of the furnish is suitably of the chemically pulped variety, such as a bleached kraft pulp, although the invention is not believed to be limited to kraft pulps, and may also be used with good effect with other chemical pulps such as sulfite pulps, mechanical pulps such as ground wood pulps, and other pulp varieties and mixtures thereof such as chemical-mechanical and thermo-mechanical pulps. While not essential to the invention, the pulp is preferably bleached to remove lignins and to achieve a desired pulp brightness according to one or more bleaching treatments known in the art including, for example, elemental chlorine-based bleaching sequences, chlorine dioxide-based bleaching sequences, chlorine-free bleaching sequences, elemental chlorine-free bleaching sequences, and combinations or variations of stages of any of the foregoing and other bleaching related sequences and stages. After bleaching is completed and the pulp is washed and screened, it is generally subjected to one or more refining steps. Thereafter, the refined pulp is passed to a blend chest where it is mixed with conventional additives such as, for example, starches, fillers, sizing agents, retention aids, and strengthening polymers. Among the fillers that may be used are organic and inorganic pigments such as, by way of example, polymeric particles such as polystyrene latexes and polymethylmethacrylate, and minerals such as calcium carbonate, kaolin, and talc. Other conventional additives include, but are not restricted to, wet strength resins, internal sizes, dry strength resins, alum, fillers, pigments and dyes and fillers typically incorporated into a papermaking furnish as well as other pulps such as unbleached pulps and/or recycled or post-consumer pulps. Other conventional additives may also include so-called “internal sizing” agents used primarily to increase the contact angle of polar liquids contacting the surface of the paper such as alkenyl succinic anhydride (ASA), alkyl ketene dimer (AKD), and rosin sizes. Retention aids may also be added at this stage. Cationic retention aids are preferred; however, anionic aids may also be employed in the furnish.

In addition, and prior to providing the furnish to the headbox of a papermaking machine, polymeric microspheres are added to the pulp furnish mixture. As noted above, the microspheres are added in an amount of from about 0.1% to about 6.0% based on the total dry weight of the furnish. The microspheres may be pre-expanded or in substantially their final dimension prior to inclusion in the furnish mixture. However, it is preferred that the microspheres are initially added to the furnish in a substantially unexpanded state and then caused to expand as the paper web is formed and dried as described hereinafter. It will be appreciated that this expansion has the effect of enabling an increased caliper and reduced density in the final paper product. It is also within the scope of the invention to include mixtures of expandable and already-expanded microspheres (or microspheres that are already substantially in their final dimensional state) in the papermaking furnish so that a portion of the microspheres will expand to a substantial degree in drying operations while the balance will remain in substantially the same overall dimensions during drying.

In step (b) of the process of this invention, the pulp suspension of step (a) is sheeted and dried to obtain dried paper or paperboard web. Methods and apparatuses for sheeting and drying a pulp suspension are well known in the paper and paperboard art. See for example G. A. Smook referenced above and references cited therein. Any conventional sheeting and drying method can be used. Consequently, these methods will not be described herein in any great detail. By way of example, the aqueous paper making stock furnish containing pulp, and other additives is deposited from the head box of a suitable paper making machine into a single or multi-ply web on a papermaking machine such as a Fourdrinier machine or any other suitable papermaking machine known in the art, as well as those which may become known in the future. For example, a so-called “slice” of furnish consisting of a relatively low consistency aqueous slurry of the pulp fibers along with the microspheres and various additives and fillers dispersed therein is ejected from a headbox onto a porous endless moving forming sheet or wire where the liquid is dewatered by gradually drained through small openings in the wire by vacuum in the forming section until a mat of pulp fibers and the other materials is formed on the wire. The dewatered wet mat or web is transferred from the forming section to the press section on specially constructed felts through a series of roll press nips that removes water and consolidates the wet web of paper. In step (c) of the preferred embodiment of the process of this invention, the paper or paperboard web is dried after treatment with the size composition. The web is then passed to an initial dryer section to remove most of the retained moisture and further consolidate the fibers in the web. The heat of the drying section also promotes expansion of unexpanded microspheres that may be contained in the web. Methods and apparatuses for drying paper or paperboard webs treated with a sizing composition are well known in the paper and paperboard art. See for example G. A. Smook referenced above and references cited therein. Any conventional drying method and apparatus can be used. Consequently, these methods and apparatuses will not be described herein in any great detail.

The dried paper or paperboard web is optimally and preferably treated by applying to at least one surface of the web a size composition comprising one or more additives. Methods and apparatuses for treating a dried web of paper or paperboard with a sizing composition are well known in the paper and paperboard art. See for example, G. A. Smook referenced above and references cited therein. Suitable size press additives include pigments and sizing agents such as starches. The starch may be of any type, including but not limited to oxidized, ethylated, cationic and pearl, and is preferably used in aqueous solution. Illustrative of useful starches for the practice of this preferred embodiment of the invention are naturally occurring carbohydrates synthesized in corn, tapioca, potato and other plants by polymerization of dextrose units. All such starches and modified forms thereof such as starch acetates, starch esters, starch ethers, starch phosphates, starch xanthates, anionic starches, cationic starches and the like which can be derived by reacting the starch with a suitable chemical or enzymatic reagent can be used in the practice of this invention. Preferred starches for use in the practice of this invention are modified starches. More preferred starches are cationic modified or non-ionic starches such as CatoSize 270 and KoFilm 280 (all from National Starch) and chemically modified starches such as PG-280 ethylated starches and AP Pearl starches. More preferred starches for use in the practice of this invention are cationic starches and chemically modified starches.

In step (d) of the preferred embodiment of the process of this invention, the dried paper or paperboard web is subjected to one or more post drying steps as for example those described in G. A. Smook referenced above and references cited therein. For example, the paper or paperboard web may be coated and/or calendered to achieve the desired final caliper as discussed above to improve the smoothness and other properties of the web. The calendering may be accomplished by steel-steel calendering equipment in one or more stacks each having one or more nips at nip pressures sufficient to provide a desired caliper. It will be appreciated that the ultimate caliper of the paper ply will be largely determined by the selection of the nip pressure. Applicants have unexpectedly discovered that the calendering pressure impacts on the stiffness of the substrate and that substrates having acceptable stiffness characteristics can be obtained at relatively lower basis weights by reducing the level of calendering. Reducing basis weight in paper and paperboard is advantageous because it increases the yield (square footage/ton of paper or paperboard). Using expandable microspheres in combination with reduced calendering allows for the greater reduction in basis weight than was originally taught in prior art while at the same time providing acceptable stiffness characteristics.

In general, in those embodiments of the paper material where increased GM Taber Stiffness is desired, the material is subjected to a maximum nip or calendering pressure equal to or less than about 350 lbs/lineal square inch (LSI). The nip or calendering pressure is preferably equal to or less than about 250/lbs/LSI, more preferably equal to or less than about 100 lbs/LSI, and most preferably equal to or less than about 50 lbs/LSI.

As noted above the paper material of this invention exhibits one or more beneficial properties. These include enhanced GM Taber Stiffness, GM Fold and/or cut resistance. As a result of these properties, the paper materials formed according to the invention may be utilized in a variety of office or clerical applications. In particular, the inventive papers are advantageously used in forming Bristol board file folder or jackets for storing and organizing materials in the office workplace. The manufacture of such folders from paper webs is well known to those in the paper converting arts and consists in general of cutting appropriately sized and shaped blanks from the paper web, typically by “reverse” die cutting, and then folding the blanks into the appropriate folder shape followed by stacking and packaging steps. The blanks may also be scored beforehand if desired to facilitate folding. The scoring, cutting, folding, stacking, and packaging operations are ordinarily carried out using automated machinery well-known to those of ordinary skill on a substantially continuous basis from rolls of the web material fed to the machinery from an unwind stand.

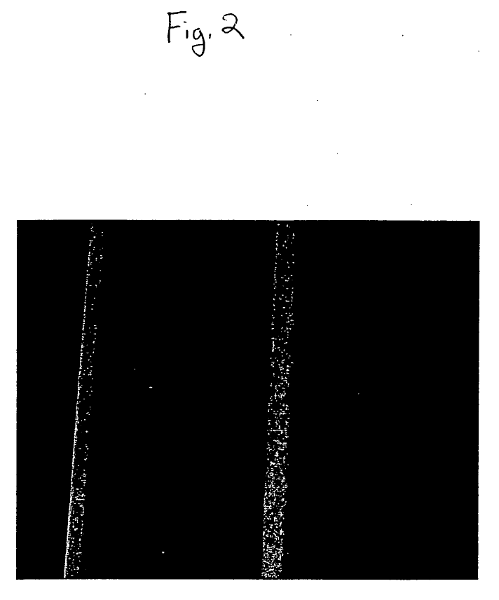

A typical apparatus for “reverse” die cutting is illustrated diagrammatically in FIG. 3. Such die cutting is in contrast to so-called “guillotine” cutting of paper. In guillotine cutting, a paper to be cut is supported by a flat, fixed surface underneath the paper, and the paper is cut by the lowering of a movable cutting blade down through the thickness of the paper and into a slot in the fixed surface dimensioned to receive the cutting blade. Guillotine cutting typically produces relatively smooth paper edges; however, guillotine cutting is generally impractical for high speed, large volume cutting applications. In reverse die cutting, a cutting blade is fixed in an upright position protruding from a housing located beneath the paper to be cut. With the blade fixed and the paper in a cutting position above the blade, a contact plate is lowered against the top of the paper and presses the paper against the edge of the cutting blade causing the blade to cut the paper.

The papers and the folders and other die cut articles formed there from, having exposed edges have been observed to exhibit a significantly reduced tendency to cut the skin of persons handling the folders as compared to prior art papers and die cut paper articles such as folders. That is, the edges of the papers are less likely to cause cutting or abrasion of the skin if the fingers or other portions of the body are inadvertently drawn against an exposed edge of the material.

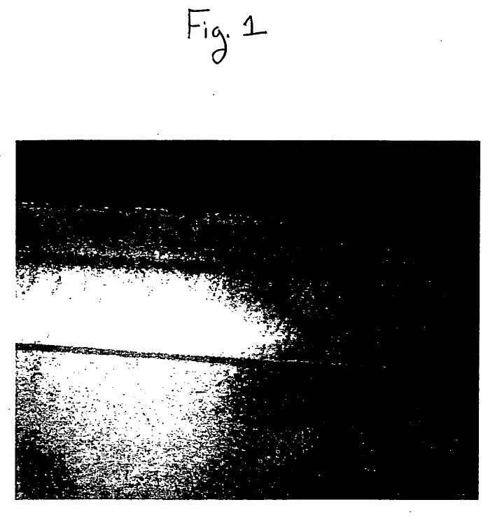

Without being bound by theory, it is believed the improvement in cut resistance derives from the combination of an increased caliper and a decreased density as compared to prior art papers and the effect of these attributes on how the paper reacts to cutting operations. As noted above, folder blanks are typically die cut. When die cutting blanks for conventional folders from prior art papers having a relatively small caliper and a relatively high density, it is believed that the die blade initially creates a clean cut through a portion of the thickness of the paper. However, before the die blade can complete a clean cut through the paper, the remainder of the paper thickness “bursts” or fractures in a relatively jagged and irregular manner. As a consequence, the resultant edge of the folder is jagged and includes a large number of very small, but very sharp paper shards. Contact with these small jagged sharp edges and shards is believed to be a primary cause of paper cut incidents. ile the resultant paper edges from die cutting are more rough and jagged than from, say, guillotine cutting, die cutting techniques are more easily implemented in large-scale, high speed manufacturing, and are therefore favored greatly in modern practice. FIG. 1 illustrates four samples of a conventional paper which have been cut by different techniques. The foremost sample in the micrograph is a paper which has been guillotine cut. The two samples depicted in the center of the micrograph are cut by a lab bench die cutter described in further detail hereinafter. The final sample, in the background of the micrograph, is cut by a conventional, production scale die cutter. As may be seen, the die cut conventional papers exhibit considerable roughness about the edges of the paper samples.

However, it has been determined that paper according to the invention having a relatively high caliper and relatively low density has a considerably reduced tendency to fracture or burst prematurely when being die cut. The die blade is apparently allowed to complete a clean cut through the paper thickness and, consequently, the resultant edge exhibits significantly fewer jagged irregularities and shards which produce paper cuts. Therefore, folders for example made according to the invention exhibit a significantly reduced tendency to cause paper cuts as they are being handled.

The differences in the resultant die cut paper edges is dramatically illustrated in FIG. 2 which depicts on the right a die-cut edge of paper formed according to the invention and to the left a die-cut edge of a conventional paper of substantially the same basis weight. The inventive paper includes about 2 wt % expanded microspheres and has a caliper of about 15 mils and a density of about 8.7 lb/3000 ft² mil. The conventional paper does not include any microspheres and has a caliper of about 11 mils and a density of about 11.3 lb/3000 ft²/mil. It may be seen that the edge of the inventive paper is significantly smoother in appearance and has a more beveled corner profile. It is believed that these differences account for the reduction in cutting tendency.

The following non-limiting examples illustrate various additional aspects of the invention. Unless otherwise indicated, temperatures are in degrees Celsius, percentages are by weight and the percent of any pulp additive or moisture is based on the oven-dry weight of the total amount of material.

### EXAMPLE 1

A series of papers were formed from a mixture of about 40% softwood pulp and about 60% hardwood pulp and having a Canadian Standard Freeness of about 450 and incorporating amounts of expandable microspheres and being calendered to a variety of differing calipers. The resultant papers containing the expanded microspheres were then tested to determine the likelihood of an edge cutting a person's fingers while being handled. In place of actual human skin, the tests were performed using a rubberized finger covered by a latex glove material which served as an artificial “skin”.

The samples for examination were die cut using a laboratory die cutter 20 illustrated in FIG. 3. The cutter includes a bottom housing 22 having a recess 24. A cutting blade 26 is mounted in a supporting block 28 and the block is fixed in the recess 24 so that the cutting blade projects upward.

The die cutter 20 also includes an upper housing 30 which is held in alignment with the lower housing by a plurality of bolts or rods 32 which are received in a corresponding plurality of holes in the upper housing 30. Over the cutting blade 26, the upper housing includes a contact surface 34. The paper sample 36 to be cut is placed in the gap between the cutting blade 26 and the contact surface 34. The contact surface 34 is then pressed downward by a hydraulic ram 38 or by other suitable driving means so that the paper sample 36 is pressed against the cutting blade and cut/burst in two.

The cutting tendencies of the edges of the paper samples were evaluated in a testing procedure referred to hereinafter as the “Cutting Index 30” test (with “30” indicating the number of replicates of the test performed). The Cutting Index 30 test uses an apparatus similar to that depicted diagrammatically in FIGS. 4 and 5. The testing apparatus 50 includes a frame 52 which supports a paper sample clamping device 54 and suspends the clamping device 54 from above. The clamping device 54 is suspended about a pivot point 56 which allows the angle of the clamping device 54 to vary relative to horizontal. In this manner, the paper may be contacted against the simulated finger at different contact angles. The paper sample 60 to be tested is held in the clamping device 54 in a substantially upright position. The testing apparatus 50 also includes a simulated finger 62 which may be drawn against the edge of the paper sample 60 in the apparatus. For instance, the finger 62 may be removably affixed to a movable base 64 which slides along a rail or track 66 by means of hydraulic actuation so that the finger 62 is drawn into contact with the edge of the paper sample 60. After the sample contacts the finger, the latex is examined to determine if a cut is produced and the cuts are then characterized according to size.

The simulated finger is preferably formed from an inner rod of metal or stiff plastic, which is covered by a somewhat flexible material such a neoprene rubber and the neoprene layer is preferably covered by a latex layer such as a finger from a latex glove. In this manner, the finger roughly simulates the bone, muscle, and skin layers of an actual finger. While the latex and neoprene structure does not exhibit the exact some tendency to be cut as an actual finger, it is believed that a relatively high incidence of cuts in this structure will generally correlate to a relatively high incidence of cuts in an actual finger and a relatively low incidence of cuts in this structure will generally correlate to a relatively low incidence of cuts in an actual finger.

In the experiments described herein, neoprene rubber layer employed has a hardness of about Shore A 50, the latex “skin” is about 0.004 inches thick, and the latex skin is attached to the neoprene using double-sided tape. In order to better simulate skin, the latex is also allowed to condition by exposure to an elevated temperature of about 125° C. for a period of about 6 hours prior to testing. Because latex is a naturally occurring substance, latexes and products produced there from exhibit some degree of variation from batch to batch with respect to certain properties such as moisture content. It was found that by conditioning the latex at the elevated temperature for about 6 hours, the resultant latex skins exhibited a more uniform set of properties and accordingly the reproducibility of test results improved.

The paper samples employed are cut to a size of about 1 inch by six inches and a die cut edge is aligned in the bottom of the clamping device to contact the finger. The simulated finger is then drawn against the paper edge, then stopped and the latex skin is examined to determine if a cut has occurred and if so, the magnitude or size of the cut.

A total of 30 replicates were performed for each paper sample. The results were as follows:

TABLE I

| Sample | % | Basis | Final | Density | | |
|---|---|---|---|---|---|---|
| ID | Expancel | weight | Caliper | (lb/3000 | Total | Cutting |
| (WMCF) | (Wt %) | (lb/3000 ft²) | (mils) | ft²/mil) | Cuts | Index |
| 1A | 0 | 127 | 11.9 | 10.7 | 19 | 45 |
| 2 | 2 | 108 | 12.0 | 9.0 | 15 | 34 |
| 3 | 3 | 108 | 12.7 | 8.5 | 17 | 29 |
| 6A | 0 | 148 | 12.1 | 12.3 | 22 | 56 |
| 6B | 0 | 182 | 14.5 | 12.6 | 18 | 30 |
| 6C | 0 | 200 | 16.2 | 12.4 | 13 | 16 |
| 124 | 2 | 131 | 15.8 | 8.3 | 7 | 15 |
| 143 | 2 | 143 | 17.0 | 8.4 | 3 | 5 |

In addition to measuring the number of cuts (out of 30 replicates), the size of each cut was characterized on a 1 to 5 scale with 1 being “very small” and 5 being “large”. Using this data, a “Cutting Index” was determined by summing the products of the number of cuts in each size category by the severity of the cut on the 1 to 5 scale. These results are shown in Table II:

TABLE II

| Sample | Total | Large | Med+ | Med | Small | V. Small | Cutting |
|---|---|---|---|---|---|---|---|
| ID | Cuts | (5) | (4) | (3) | (2) | (1) | Index |
| 1A | 19 | 0 | 3 | 5 | 7 | 4 | 45 |
| 2 | 15 | 0 | 1 | 3 | 10 | 1 | 34 |
| 3 | 17 | 0 | 0 | 1 | 10 | 6 | 29 |
| 6A | 22 | 0 | 4 | 8 | 6 | 4 | 56 |
| 6B | 18 | 0 | 0 | 6 | 0 | 12 | 30 |
| 6C | 13 | 0 | 0 | 0 | 3 | 10 | 16 |
| 124 | 7 | 0 | 0 | 3 | 2 | 2 | 15 |
| 143 | 3 | 0 | 0 | 0 | 2 | 1 | 5 |

As may be seen in samples 1-3 and 6A, the density of the papers was varied by addition of varying amounts of expanded microspheres while the paper calipers were held approximately constant at about 12 mils. These samples demonstrate that a reduction of density associated with inclusion of microspheres leads to a corresponding reduction in the number and severity of cuts produced by the paper.

In samples 6A-6C, the paper density was held approximately constant at about 12.5 lb/3000 ft²/mil while the caliper of the papers was varied. The results demonstrate a clear correlation between increasing caliper and decreasing cuts and cut severity in a paper containing the microspheres.

Finally, in samples 124 and 143, papers were produced containing microspheres and employing both a reduced density and a high caliper at the same time. The results were quite dramatic with number of cuts and the weight average cuts both being reduced to extremely low levels. Thus, it appears that while both caliper increase and density reduction in association with addition of microspheres may individually reduce cutting to some degree, the combination of the two appears to provide a synergistic reduction in cutting which is surprising and quite unexpected.

### EXAMPLE 2

A similar set of tests were conducted using a series of papers formed from a second pulp furnish, again formed from a mixture of about 40% softwood pulp and about 60% hardwood pulp and having a Canadian Standard Freeness of about 450. In these tests, two sets of papers were produced, with each set of papers having approximately the same basis weight. For one group of papers, the basis weight was on the order of about 130 lb/3000 ft² and for the second group, the basis weight was about 150 lb/3000 ft². Within each group, various amounts of microspheres were added and the resultant paper caliper varied. Again, 30 replicates of each sample were tested for cutting tendency. The results are shown in Tables III and IV.

TABLE III

| Sample | % | Basis | Final | Density | | |
|---|---|---|---|---|---|---|
| ID | Expancel | weight | Caliper | (lb/3000 | Total | Cutting |
| (WMCF) | (Wt %) | (lb/3000 ft²) | (mils) | ft²/mil) | Cuts | Index |
| 1 | 0 | 129 | 12.1 | 10.7 | 21 | 77 |
| 3 | 2 | 133 | 15.5 | 8.58 | 15 | 34 |
| 4 | 3 | 128 | 17.2 | 7.46 | 10 | 16 |
| 5 | 0 | 153 | 13.8 | 11.1 | 25 | 80 |
| 7 | 2 | 149 | 14.6 | 10.2 | 16 | 36 |
| 8 | 3 | 150 | 18.4 | 8.15 | 7 | 12 |

These results show a clear trend toward decreases in total cuts as well as the weighted average cuts with increasing amount of microspheres where the basis weight is held about the same. It is seen that increasing the amount of microspheres while holding the basis weight the same can be said to result in an increased caliper, decreased density, and decreased number and severity of cuts.

TABLE IV

| Sample | Total | Large | Med+ | Med | Small | V. Small | Cutting |
|---|---|---|---|---|---|---|---|
| ID | Cuts | (5) | (4) | (3) | (2) | (1) | Index |
| 1 | 21 | 7 | 5 | 5 | 3 | 1 | 77 |
| 3 | 15 | 0 | 2 | 1 | 8 | 3 | 34 |
| 4 | 10 | 0 | 0 | 0 | 6 | 4 | 16 |
| 5 | 25 | 2 | 9 | 6 | 8 | 0 | 80 |
| 7 | 16 | 0 | 0 | 4 | 12 | 0 | 36 |
| 8 | 7 | 0 | 0 | 0 | 5 | 2 | 12 |

### EXAMPLE 3

A similar set of tests were conducted using a series of papers formed from a third pulp furnish including about 35% softwood fibers and about 65% hardwood fibers. Again, 30 replicates of each sample were tested for cutting tendency. The results are shown in Tables V.

TABLE V

| | | | Final | Density | | |
|---|---|---|---|---|---|---|
| Sample | % Expancel | Basis weight | Caliper | (lb/3000 | Total | Cutting |
| ID | (Wt. %) | (lb/3000 ft2) | (Mils) | ft2/mil) | Cuts | Index |
| 124 lb | 0 | 129 | 11.39 | 11.34 | 28 | 116 |
| control | | | | | | |
| 143 lb | 0 | 148 | 11.57 | 12.76 | 30 | 95 |
| control | | | | | | |
| 4 | 2 | 128 | 14.83 | 8.61 | 15 | 21 |
| 6 | 2 | 125 | 15.21 | 8.22 | 7 | 9 |
| 7 | 2 | 124 | 14.94 | 8.28 | 5 | 5 |
| 8 | 2 | 125 | 15.08 | 8.27 | 15 | 15 |
| 9 | 2 | 125 | 14.56 | 8.62 | 8 | 9 |

In these tests, the papers containing expanded microspheres were produced to provide a target basis weight of about 124 lb/3000 ft² and compared to two controls formed with no microspheres and having basis weights of 124 lb/3000 ft² and 143 lb/3000 ft² respectively. The expanded microsphere samples again showed dramatic reductions in cutting tendency as compared to the control papers. The total number of cuts was reduced by about 50% or more in each case and the reductions in average weighted cuts was reduced further still.

### EXAMPLE 4

A series of papers were formed from a mixture of about 50% softwood pulp, 20% hardwood pulp, and 30% post consumer waste (PCW) pulp having a Canadian standard freeness of about 450 ml. The pulp mixture was sized with 0.09 weight % ASA. Also to the mixture 7.0 weight % of ground calcium carbonate was added. Paper sample with and without expandable microspheres were produced. For the samples that contained expandable microspheres, the expandable microspheres were added to the pulp mixture. The samples that contained expandable microspheres had approximately 1 weight % in the sheet. The pulp mixture was then formed into a web on a pilot paper machine. A variety of basis weights were produced targeting 90, 100 and 118 lb/3000 ft². The papers, while still on the paper machine, were sized with a solution of 11% starch. The papers were not calendered on the paper machine but rather collected, sheeted and calendered using a laboratory sheet fed calender. The sheets were calendered under a nip load of 0, 30, 110, 170, 230 and 310 lbs LSI to produce paper samples at a varieties of densities. Density is defined as the basis weight in lb/3000 ft2 divided by the caliper in mils.

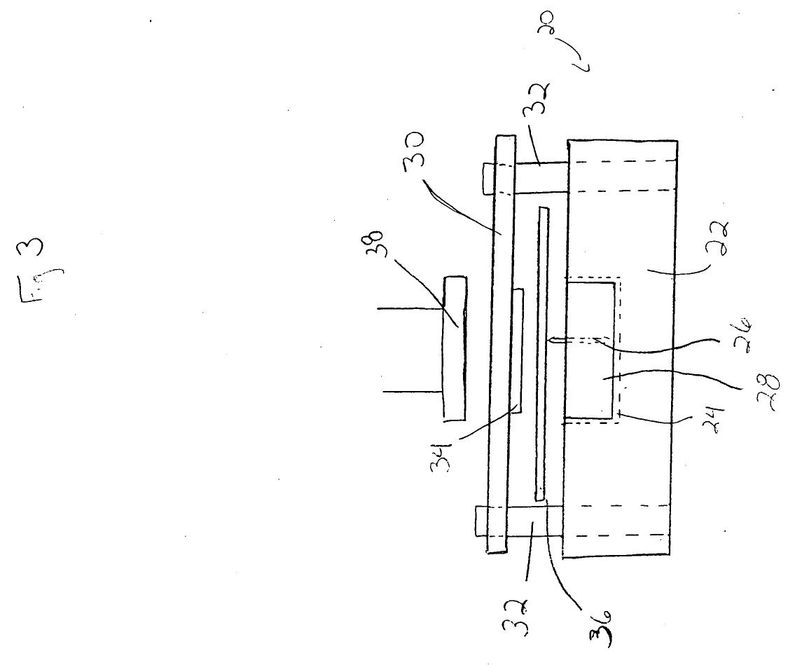

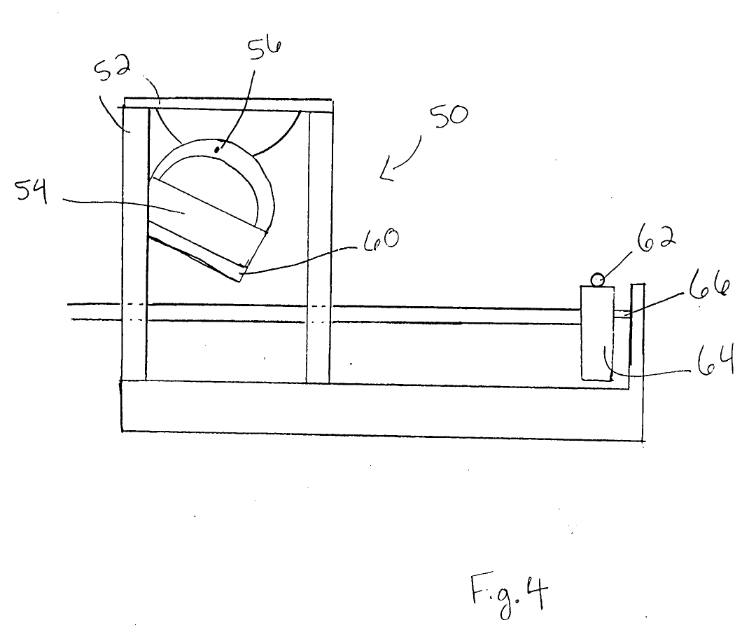

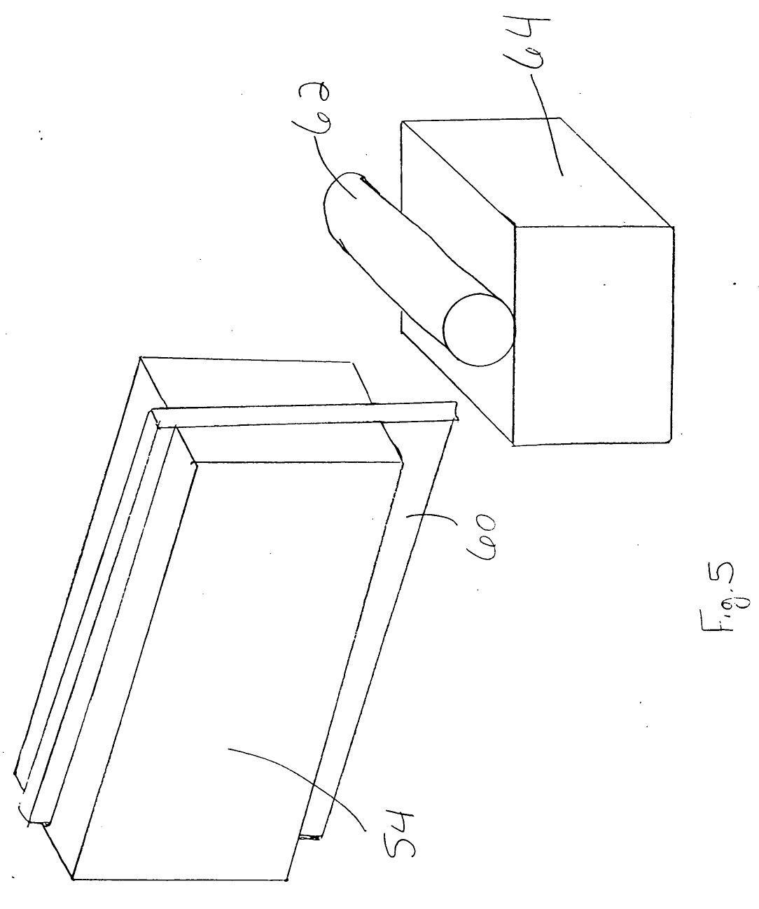

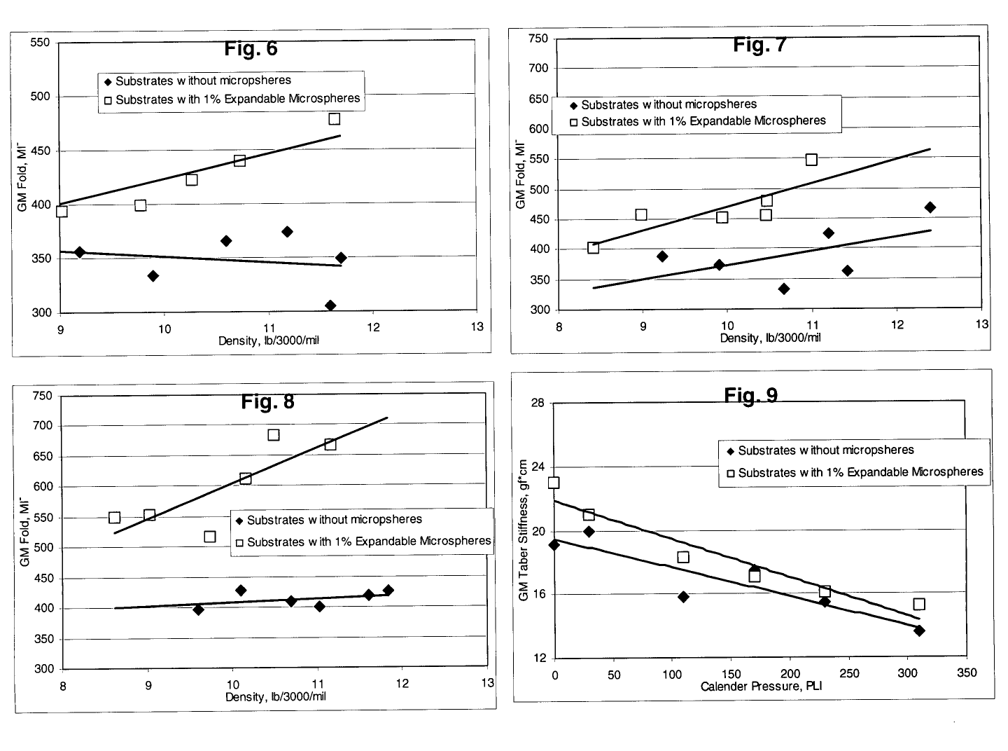

The resulting paper and paperboard substrates were tested for MD and CD MIT Fold using TAPPI test method T 511 om-88, which is a measure of the folding endurance of paper used to estimate the ability of paper to withstand repeated bending, folding, and creasing. This is an important criteria if the substrates are used in the manufacture of paper or paperboard articles having a fold or score line about which portions of the articles may be flexed as for example file folders. The results are set forth in the following Tables IV, V and VI and in FIGS. 6, 7 and 8.

Tables IV, V and VI contain the calender pressure, % expandable microspheres, basis weight, density, MD MIT Fold, CD MIT Fold and the Geometric Mean Fold for the 90 lb/3000 ft², 100 lb/3000 ft² and 118 lb/3000 ft² samples, respectively. The geometric mean of the MIT Fold and Taber Stiffness are calculated from the MD and CD properties using this equation:

$$Geometric Mean = \sqrt{\frac{{( MD )}^{2} + {( CD )}^{2}}{2}} .$$

TABLE IV

| | | | | | MD Fold: | CD Fold: | |
|---|---|---|---|---|---|---|---|
| | | | Basis | | MIT | MIT | Geometric |
| | Calender | % Expandable | Weight, | Density, | Double, | Double, | Mean Fold, |
| Substrate ID | PLI | microspheres | lb/3000 ft2 | lb/3000 ft2/mil | number | number | MIT Double |
| 90-0-20-0 | 0 | 0 | 92.3 | 9.18 | 488 | 127 | 356.6 |
| 90-0-20-6 | 30 | 0 | 90.6 | 9.89 | 451 | 137 | 333.3 |
| 90-0-20-10 | 110 | 0 | 92.5 | 10.60 | 496 | 144 | 365.2 |
| 90-0-20-13 | 170 | 0 | 90.5 | 11.19 | 504 | 156 | 373.1 |
| 90-0-20-16 | 230 | 0 | 92.8 | 11.70 | 477 | 128 | 349.2 |
| 90-0-20-20 | 310 | 0 | 91.8 | 11.59 | 386 | 193 | 305.2 |
| 90-1.0-20-0 | 0 | 1 | 92.7 | 8.16 | 531 | 199 | 401.0 |
| 90-1.0-20-6 | 30 | 1 | 91.9 | 9.02 | 538 | 147 | 394.4 |
| 90-1.0-20-10 | 110 | 1 | 93.3 | 9.78 | 529 | 197 | 399.2 |
| 90-1.0-20-13 | 170 | 1 | 92.4 | 10.27 | 572 | 170 | 422.0 |
| 90-1.0-20-16 | 230 | 1 | 88.9 | 10.74 | 602 | 156 | 439.7 |
| 90-1.0-20-20 | 310 | 1 | 92.6 | 11.65 | 652 | 176 | 477.5 |

TABLE V

| | | | | | MD Fold: | CD Fold: | Geometric |
|---|---|---|---|---|---|---|---|
| | | % | | | MIT | MIT | Mean |
| | Calender | Expandable | Basis Weight, | Density, | Double, | Double, | Fold, MIT |
| Substrate ID | PLI | microspheres | lb/3000 ft2 | lb/3000 ft2/mil | number | number | Double |
| 100-0-20-0 | 0 | 0 | 99.9 | 9.22 | 525 | 161 | 388.3 |
| 100-0-20-6 | 30 | 0 | 98 | 9.91 | 513 | 120 | 372.5 |
| 100-0-20-10 | 110 | 0 | 106 | 10.67 | 452 | 130 | 332.6 |
| 100-0-20-13 | 170 | 0 | 101 | 11.20 | 582 | 144 | 423.9 |
| 100-0-20-16 | 230 | 0 | 99.8 | 11.42 | 501 | 106 | 362.1 |
| 100-0-20-20 | 310 | 0 | 98.7 | 12.40 | 615 | 241 | 467.1 |
| 100-1.0-20-0 | 0 | 1 | 102 | 8.41 | 513 | 245 | 402.0 |
| 100-1.0-20-6 | 30 | 1 | 103 | 8.99 | 626 | 166 | 457.9 |
| 100-1.0-20-10 | 110 | 1 | 105 | 9.94 | 588 | 247 | 451.0 |
| 100-1.0-20-13 | 170 | 1 | 101 | 10.48 | 637 | 228 | 478.4 |
| 100-1.0-20-16 | 230 | 1 | 103 | 10.46 | 615 | 190 | 455.2 |
| 100-1.0-20-20 | 310 | 1 | 104 | 11.01 | 742 | 220 | 547.2 |

TABLE VI

| | | | | | MD Fold: | CD Fold: | |
|---|---|---|---|---|---|---|---|
| | | | Basis | | MIT | MIT | Geometric |
| | Calender | % Expandable | Weight, | Density, | Double, | Double, | Mean Fold, |
| Substrate ID | PLI | microspheres | lb/3000 ft2 | lb/3000 ft2/mil | number | number | MIT Double |
| 118-0-20-0 | 0 | 0 | 123 | 9.60 | 535 | 171 | 397.2 |
| 118-0-20-6 | 30 | 0 | 122 | 10.10 | 547 | 260 | 428.3 |
| 118-0-20-10 | 110 | 0 | 119 | 10.69 | 539 | 210 | 409.0 |
| 118-0-20-13 | 170 | 0 | 121 | 11.03 | 535 | 187 | 400.7 |
| 118-0-20-16 | 230 | 0 | 118 | 11.84 | 535 | 274 | 425.0 |
| 118-0-20-20 | 310 | 0 | 123 | 11.60 | 554 | 207 | 418.2 |
| 118-1.0-20-0 | 0 | 1 | 121 | 8.62 | 738 | 242 | 549.2 |
| 118-1.0-20-6 | 30 | 1 | 120 | 9.04 | 723 | 302 | 554.0 |
| 118-1.0-20-10 | 110 | 1 | 123 | 9.74 | 695 | 223 | 516.1 |
| 118-1.0-20-13 | 170 | 1 | 121 | 10.17 | 836 | 220 | 611.3 |
| 118-1.0-20-16 | 230 | 1 | 120 | 10.50 | 928 | 270 | 683.4 |
| 118-1.0-20-20 | 310 | 1 | 121 | 11.17 | 916 | 221 | 666.3 |

FIGS. 6, 7 and 8 are plots of the Geometric Mean MIT Fold versus density for the 90 lb/3000 ft², 100 lb/3000 ft² and 118 lb/3000 ft² samples, respectively. A comparison of the GM Fold data, as shown in the FIGS. 6, 7 and 8, clearly shows that the addition of 1 weight % expandable microspheres has an advantageous effect on Fold. This advantageous affect is greater at increasing density, which was unexpected.

### EXAMPLE 5

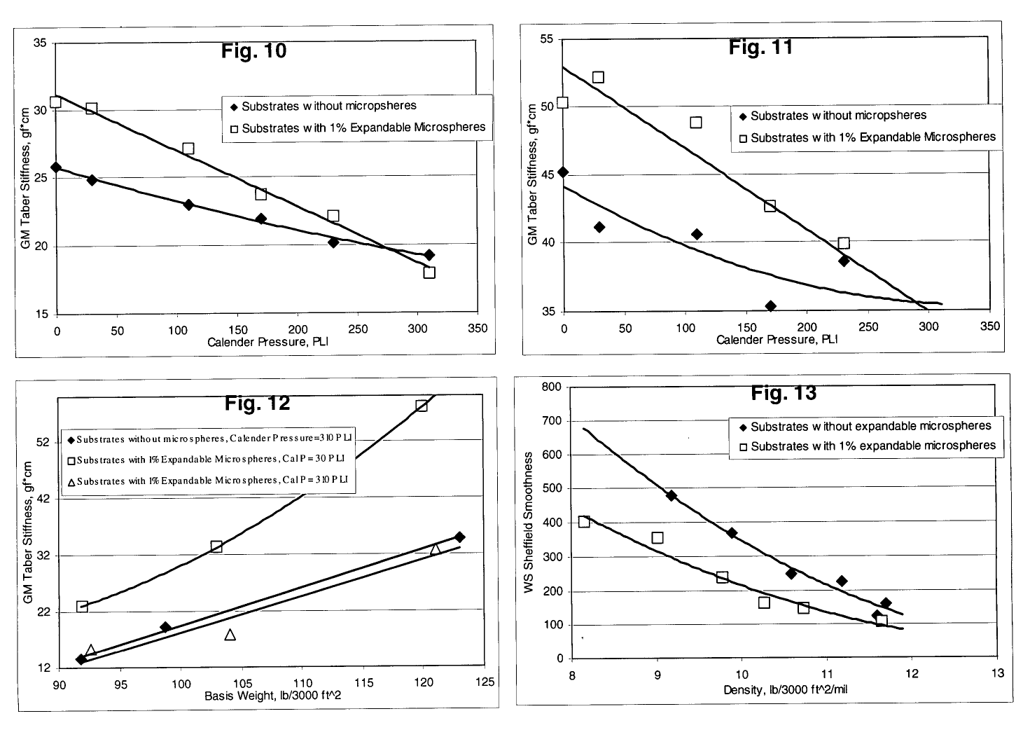

The resulting paper and paperboard substrates Example 4 were also tested for Taber Stiffness using TAPPI Test Method T 489 om-92. This procedure is used to measure the stiffness of paper and paperboard by determining the bending moment in gram centimeters necessary to deflect the free end of a 38 mm wide vertically clamed specimen 15 degrees from its centerline when the load is applied 50 mm away from the clamp. The stiffness is paper and paperboard is closely related to the economic value of the substrate and is closely related to the amount of fiber in the paper or paperboard. In this patent we are able to remove fiber and replace it with a small quantity of expandable microspheres and still achieve this desirable property to retain the paper and paperboard's economic value. Enhanced stiffness is an important criteria if the substrates are used in the manufacture of paper or paperboard articles as for example file folders, hang folders, x-ray jackets and envelope paper. The results are set forth in the following Tables VII, VIII, and IX and in FIGS. 9, 10 and 11. Tables VII, VIII, and IX contain the calender pressure, % expandable microspheres, basis weight, density, MD Taber Stiffness, CD Taber Stiffness and the Geometric Mean Taber Stiffness for the 90 lb/3000 ft², 100 lb/3000 ft² and 118 lb/3000 ft² samples, respectively.

TABLE VII

| | | | | | | | Geometric |
|---|---|---|---|---|---|---|---|
| | | | Basis | | MD Taber | CD Taber | Mean Taber |
| | Calender | % Expandable | Weight, | Density, | Stiffness, | Stiffness, | Stiffness, |
| Substrate ID | PLI | microspheres | lb/3000 ft2 | lb/3000 ft2/mil | gf * cm | gf * cm | gf * cm |
| 90-0-20-0 | 0 | 0 | 92.3 | 9.18 | 24.5 | 11.4 | 19.1 |
| 90-0-20-6 | 30 | 0 | 90.6 | 9.89 | 25.2 | 12.8 | 20.0 |
| 90-0-20-10 | 110 | 0 | 92.5 | 10.60 | 19.8 | 10.3 | 15.8 |
| 90-0-20-13 | 170 | 0 | 90.5 | 11.19 | 22.3 | 10.6 | 17.5 |
| 90-0-20-16 | 230 | 0 | 92.8 | 11.70 | 19.6 | 9.7 | 15.5 |
| 90-0-20-20 | 310 | 0 | 91.8 | 11.59 | 17.1 | 8.75 | 13.6 |
| 90-1.0-20-0 | 0 | 1 | 92.7 | 8.16 | 29 | 14.8 | 23.0 |
| 90-1.0-20-6 | 30 | 1 | 91.9 | 9.02 | 26.5 | 13.4 | 21.0 |
| 90-1.0-20-10 | 110 | 1 | 93.3 | 9.78 | 22.7 | 12.5 | 18.3 |
| 90-1.0-20-13 | 170 | 1 | 92.4 | 10.27 | 21 | 11.8 | 17.0 |
| 90-1.0-20-16 | 230 | 1 | 88.9 | 10.74 | 19.9 | 11.1 | 16.1 |
| 90-1.0-20-20 | 310 | 1 | 92.6 | 11.65 | 18.9 | 10.4 | 15.3 |

TABLE VIII

| | | | | | | | Geometric |
|---|---|---|---|---|---|---|---|
| | | | | | | | Mean |
| | | % | | | MD Taber | CD Taber | Taber |
| | Calender | Expandable | Basis Weight, | Density, | Stiffness, | Stiffness, | Stiffness, |
| Substrate ID | PLI | microspheres | lb/3000 ft2 | lb/3000 ft2/mil | gf * cm | gf * cm | gf * cm |
| 100-0-20-0 | 0 | 0 | 99.9 | 9.22 | 33 | 15.5 | 25.8 |
| 100-0-20-6 | 30 | 0 | 98 | 9.91 | 31.7 | 15.2 | 24.9 |
| 100-0-20-10 | 110 | 0 | 106 | 10.67 | 29.3 | 14.1 | 23.0 |
| 100-0-20-13 | 170 | 0 | 101 | 11.20 | 27.8 | 13.8 | 21.9 |
| 100-0-20-16 | 230 | 0 | 99.8 | 11.42 | 25.7 | 12.3 | 20.1 |
| 100-0-20-20 | 310 | 0 | 98.7 | 12.40 | 23.9 | 12.8 | 19.2 |
| 100-1.0-20-0 | 0 | 1 | 102 | 8.41 | 37.8 | 21 | 30.6 |
| 100-1.0-20-6 | 30 | 1 | 103 | 8.99 | 37.6 | 20.1 | 30.1 |
| 100-1.0-20-10 | 110 | 1 | 105 | 9.94 | 34.4 | 16.9 | 27.1 |
| 100-1.0-20-13 | 170 | 1 | 101 | 10.48 | 29.8 | 15.3 | 23.7 |
| 100-1.0-20-16 | 230 | 1 | 103 | 10.46 | 27.8 | 14.2 | 22.1 |
| 100-1.0-20-20 | 310 | 1 | 104 | 11.01 | 22.2 | 12 | 17.8 |

TABLE IX

| | | | | | | | Geometric |
|---|---|---|---|---|---|---|---|
| | | | | | | | Mean |
| | | % | | | MD Taber | CD Taber | Taber |
| | Calender | Expandable | Basis Weight, | Density, | Stiffness, | Stiffness, | Stiffness, |
| Substrate ID | PLI | microspheres | lb/3000 ft2 | lb/3000 ft2/mil | gf * cm | gf * cm | gf * cm |
| 118-0-20-0 | 0 | 0 | 123 | 9.60 | 57.4 | 28.2 | 45.2 |
| 118-0-20-6 | 30 | 0 | 122 | 10.10 | 51.4 | 27.4 | 41.2 |
| 118-0-20-10 | 110 | 0 | 119 | 10.69 | 51.4 | 25.5 | 40.6 |
| 118-0-20-13 | 170 | 0 | 121 | 11.03 | 44.6 | 22.4 | 35.3 |
| 118-0-20-16 | 230 | 0 | 118 | 11.84 | 49.6 | 22.6 | 38.5 |
| 118-0-20-20 | 310 | 0 | 123 | 11.60 | 44.2 | 21.5 | 34.8 |
| 118-1.0-20-0 | 0 | 1 | 121 | 8.62 | 62.9 | 33.3 | 50.3 |
| 118-1.0-20-6 | 30 | 1 | 120 | 9.04 | 64.4 | 36 | 52.2 |
| 118-1.0-20-10 | 110 | 1 | 123 | 9.74 | 62 | 30.2 | 48.8 |
| 118-1.0-20-13 | 170 | 1 | 121 | 10.17 | 53.9 | 26.9 | 42.6 |
| 118-1.0-20-16 | 230 | 1 | 120 | 10.50 | 50.1 | 25.8 | 39.8 |
| 118-1.0-20-20 | 310 | 1 | 121 | 11.17 | 40.1 | 23.4 | 32.8 |

FIGS. 9, 10 and 11 are plots of the Geometric Mean Taber Stiffness versus calender pressure for the 90 lb/3000 ft², 100 lb/3000 ft² and 118 lb/3000 ft² samples, respectively. A comparison of the GM Taber Stiffness, as shown in the FIGS. 9, 10 and 11, clearly shows that the addition of 1 weight % expandable microspheres has an advantageous effect on Stiffness. This is particularly evident at low calender pressures as the difference in stiffness in greater between samples containing expandable microspheres and not containing expandable microspheres than it is a higher calender pressure. This advantageous affect is greater at decreasing calender pressure, which was unexpected.

### EXAMPLE 6

The data set forth in Examples 4 and 5 was evaluated to determine the effect of calendering on the stiffness of the paper and paperboard substrate. The results are set forth in the following Table X and in FIG. 12.

TABLE X

| | | | | | | | Geometric |
|---|---|---|---|---|---|---|---|
| | | | | | | | Mean |
| | | % | | | MD Taber | CD Taber | Taber |
| | Calender | Expandable | Basis Weight, | Density, | Stiffness, | Stiffness, | Stiffness, |
| Substrate ID | PLI | microspheres | lb/3000 ft2 | lb/3000 ft2/mil | gf * cm | gf * cm | gf * cm |
| 90-0-20-20 | 310 | 0 | 91.8 | 11.59 | 17.1 | 8.8 | 13.6 |
| 100-0-20-20 | 310 | 0 | 98.7 | 12.40 | 23.9 | 12.8 | 19.2 |
| 118-0-20-20 | 310 | 0 | 123 | 11.60 | 44.2 | 21.5 | 34.8 |
| 90-1.0-20-6 | 30 | 1 | 91.9 | 9.02 | 26.5 | 13.4 | 21.0 |
| 100-1.0-20-6 | 30 | 1 | 103 | 8.99 | 37.6 | 20.1 | 30.1 |
| 118-1.0-20-6 | 30 | 1 | 120 | 9.04 | 64.4 | 36.0 | 52.2 |
| 90-1.0-20-20 | 310 | 1 | 92.6 | 11.65 | 18.9 | 10.4 | 15.3 |
| 100-1.0-20-20 | 310 | 1 | 104 | 11.01 | 22.2 | 12.0 | 17.8 |
| 118-1.0-20-20 | 310 | 1 | 121 | 11.17 | 40.1 | 23.4 | 32.8 |

Table X and FIG. 12 clearly demonstrate that adding expandable microspheres to paper or paperboard allows the basis weight of the paper or paperboard to be reduced while still maintaining a comparable stiffness of a higher weight paper or paperboard. FIG. 12 is a plot of GM Taber Stiffness versus basis weight for papers with and without expandable microspheres and at different levels of calendering. The figure clearly shows that at any given basis weight, the papers with 1 weight % of expandable microspheres in combination with a reduce level of calendering have a significantly higher stiffness than papers with 1 weight % or without expandable microspheres under normal calendering conditions. This allows for a reduction in basis weight while maintaining stiffness. Thus, by reducing the level of calendering an even lower basis weight with comparable stiffness can be achieved. Reducing basis weight in paper and paperboard is advantageous because it increases the yield (square footage/ton of paper or paperboard). Using expandable microspheres in combination with reduced calendering allows for the greater reduction in basis weight than was originally taught in prior art of using expandable microspheres in paper or paperboard. This was an unexpected result.

### EXAMPLE 7

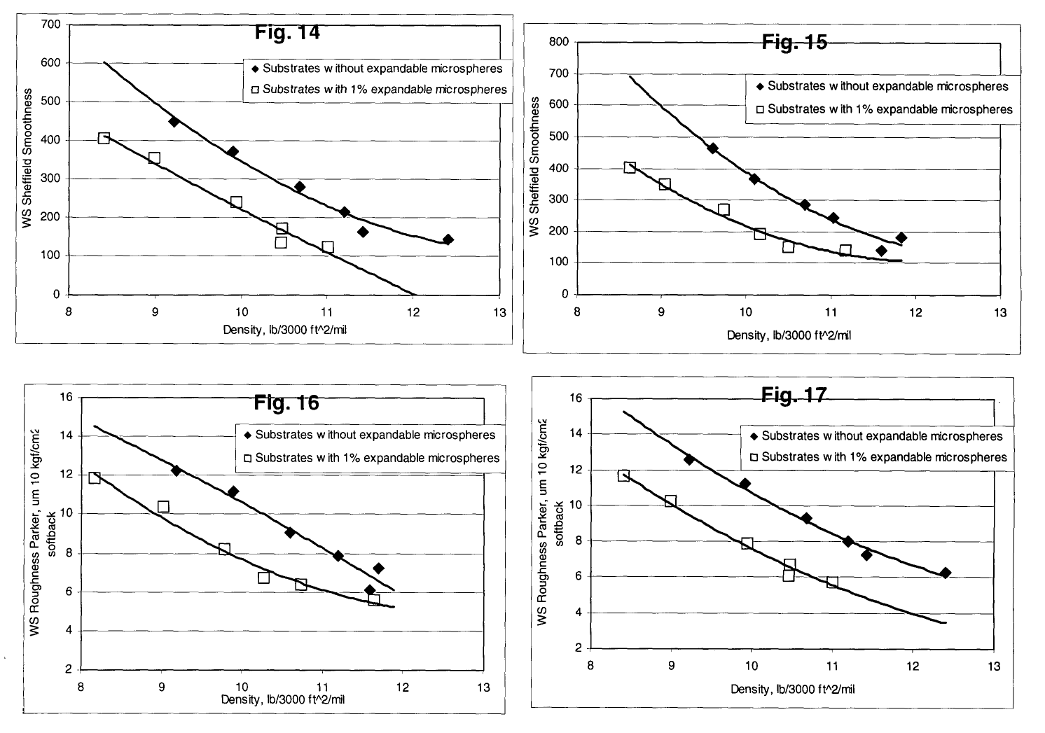

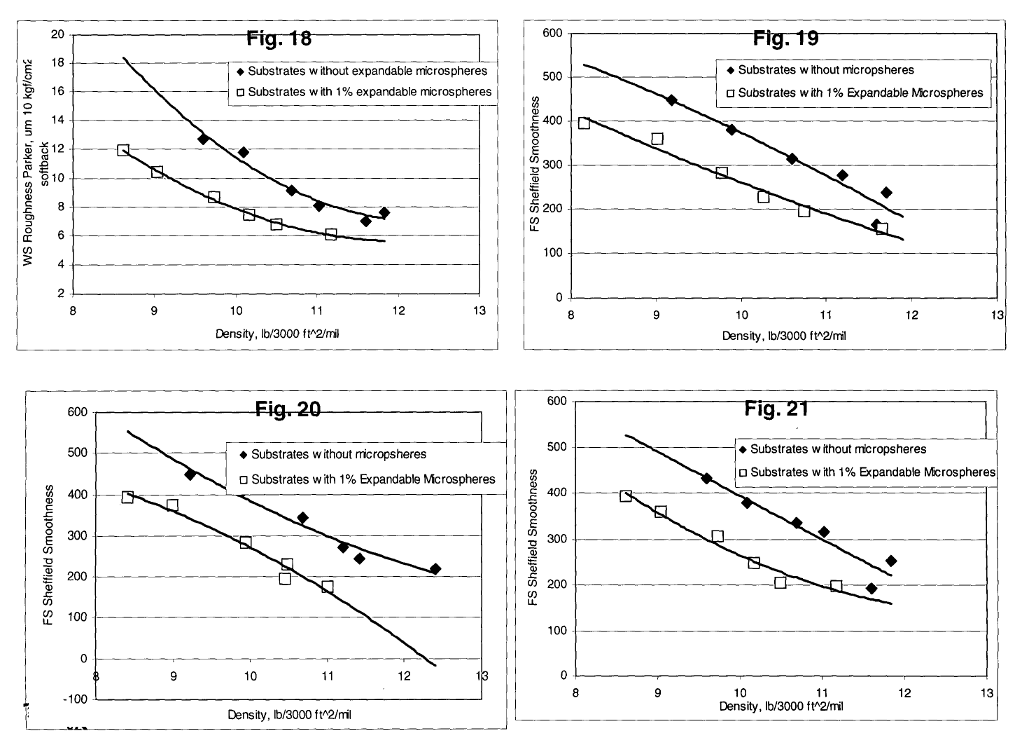

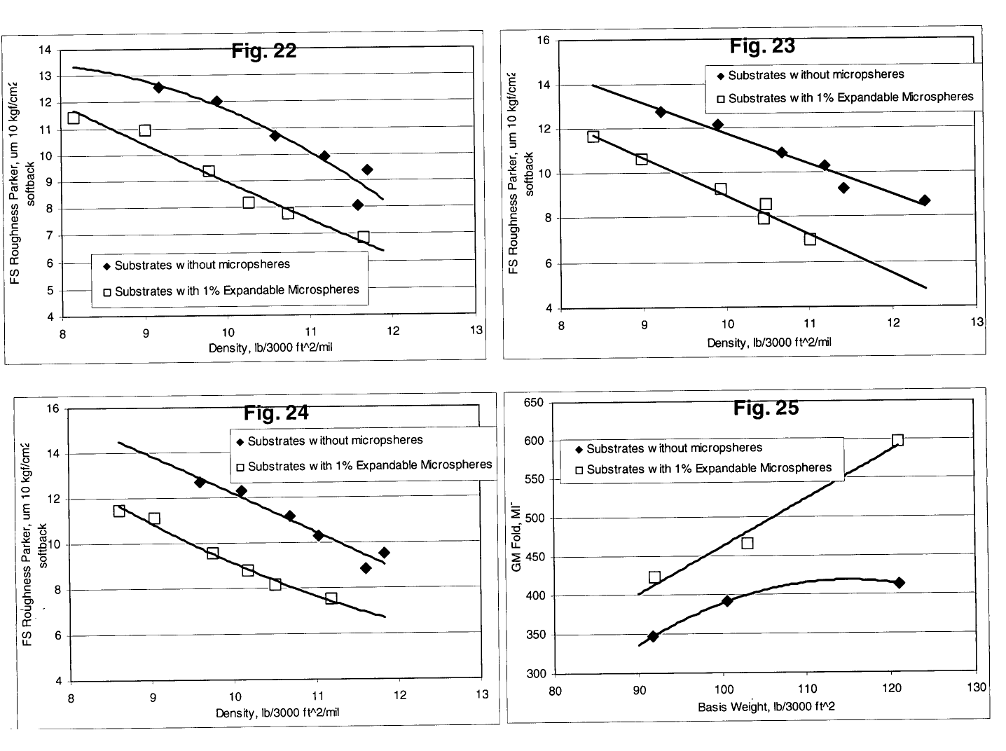

The paper and paperboard substrates from Examples 4, 5 and 6 were also tested for smoothness employing Tappi test methods T 538 om-88 (Smoothness of Paper and Paperboard (Sheffield Method)) and T 555 om-99 (Roughness of paper and paperboard (Print-surf method)). The results are set forth in Tables XI, XII, XIII and FIGS. 13, 14, 15, 16, 17, 18, 19, 20, 21, 22, 23, and 24. Tables XI, XII, XIII contain the density, wire side Sheffield smoothness, wire side Parker Print-surf roughness, felt side Sheffield smoothness and felt side Parker Print-surf roughness for the 90 lb/3000 ft², 100 lb/3000 ft² and the 118 lb/3000 ft² samples, respectively. In printing grade paper and paperboard surface roughness has a significant factor in determining printability. Smoothness also affects other properties such as coefficient of friction, gloss and coating absorption. The Sheffield test is a measure of the air flow between the substrate and a glass surface. Surface smoothness is related to the rate of air flow measured between the two pressurized concentric annular lands impressed into the sample. The Parker print surf method measures the roughness of paper and paperboard under conditions simulating letterpress, litho, and gravure printing processes. The average value of roughness, expressed in micrometers, can in some cases correlate better to printability than other comparable methods like Sheffield.

TABLE XI

| | | Wire Side | | Felt Side | Felt Side Parker |
|---|---|---|---|---|---|
| | | Sheffield | Wire Side Parker | Sheffield | Print Surf, um |
| | Density, | Smoothness, | Print Surf, um 10 kgf/cm2 | Smoothness, | 10 kgf/cm2 |
| Substrate ID | lb/3000 ft2/mil | Sheff. Units | softback | Sheff. Units | softback |
| 90-0-20-0 | 9.18 | 478 | 12.25 | 448 | 12.57 |
| 90-0-20-6 | 9.89 | 369 | 11.18 | 380 | 12.03 |
| 90-0-20-10 | 10.60 | 246 | 9.04 | 316 | 10.71 |
| 90-0-20-13 | 11.19 | 223 | 7.88 | 277 | 9.91 |
| 90-0-20-16 | 11.70 | 160 | 7.25 | 237 | 9.37 |
| 90-0-20-20 | 11.59 | 123 | 6.08 | 164 | 8.07 |
| 90-1.0-20-0 | 8.16 | 402 | 11.83 | 396 | 11.43 |
| 90-1.0-20-6 | 9.02 | 353 | 10.35 | 361 | 10.95 |
| 90-1.0-20-10 | 9.78 | 239 | 8.18 | 282 | 9.38 |
| 90-1.0-20-13 | 10.27 | 164 | 6.73 | 227 | 8.19 |
| 90-1.0-20-16 | 10.74 | 145 | 6.39 | 195 | 7.74 |
| 90-1.0-20-20 | 11.65 | 107 | 5.58 | 156 | 6.85 |

TABLE XII

| | | Wire Side | | Felt Side | Felt Side Parker |
|---|---|---|---|---|---|
| | | Sheffield | Wire Side Parker | Sheffield | Print Surf, um |
| | Density, | Smoothness, | Print Surf, um 10 kgf/cm2 | Smoothness, | 10 kgf/cm2 |
| Substrate ID | lb/3000 ft2/mil | Sheff. Units | softback | Sheff. Units | softback |
| 100-0-20-0 | 9.22 | 449 | 12.58 | 449 | 12.76 |
| 100-0-20-6 | 9.91 | 371 | 11.26 | 409 | 12.13 |
| 100-0-20-10 | 10.67 | 281 | 9.32 | 345 | 10.88 |
| 100-0-20-13 | 11.20 | 213 | 8 | 273 | 10.27 |
| 100-0-20-16 | 11.42 | 162 | 7.25 | 245 | 9.22 |
| 100-0-20-20 | 12.40 | 142 | 6.27 | 220 | 8.65 |
| 100-1.0-20-0 | 8.41 | 405 | 11.65 | 394 | 11.64 |
| 100-1.0-20-6 | 8.99 | 353 | 10.25 | 373 | 10.63 |
| 100-1.0-20-10 | 9.94 | 240 | 7.88 | 284 | 9.24 |
| 100-1.0-20-13 | 10.48 | 171 | 6.73 | 230 | 8.52 |
| 100-1.0-20-16 | 10.46 | 135 | 6.08 | 195 | 7.92 |
| 100-1.0-20-20 | 11.01 | 122 | 5.72 | 175 | 6.98 |

TABLE XIII

| | | Wire Side | | Felt Side | Felt Side Parker |
|---|---|---|---|---|---|
| | | Sheffield | Wire Side Parker | Sheffield | Print Surf, um |
| | Density, | Smoothness, | Print Surf, um 10 kgf/cm2 | Smoothness, | 10 kgf/cm2 |
| Substrate ID | lb/3000 ft2/mil | Sheff. Units | softback | Sheff. Units | softback |
| 118-0-20-0 | 9.60 | 463 | 12.76 | 432 | 12.67 |
| 118-0-20-6 | 10.10 | 367 | 11.8 | 379 | 12.28 |
| 118-0-20-10 | 10.69 | 286 | 9.1 | 334 | 11.15 |
| 118-0-20-13 | 11.03 | 243 | 8.08 | 315 | 10.31 |
| 118-0-20-16 | 11.84 | 181 | 7.6 | 253 | 9.52 |
| 118-0-20-20 | 11.60 | 141 | 6.98 | 193 | 8.84 |
| 118-1.0-20-0 | 8.62 | 403 | 11.95 | 392 | 11.45 |
| 118-1.0-20-6 | 9.04 | 350 | 10.39 | 359 | 11.13 |
| 118-1.0-20-10 | 9.74 | 268 | 8.66 | 305 | 9.54 |
| 118-1.0-20-13 | 10.17 | 192 | 7.43 | 248 | 8.79 |
| 118-1.0-20-16 | 10.50 | 149 | 6.75 | 206 | 8.15 |
| 118-1.0-20-20 | 11.17 | 138 | 6.05 | 198 | 7.53 |

The results clearly show that at a given density, the paper or paperboard with expandable microspheres is smoother that paper or paperboard without expandable microspheres. This was demonstrated for both the Sheffield and Parker Print Surf tests. The improved smoothness at a given density in the paper containing microspheres was an unexpected result and would benefit printing grades of paper and paperboard.

### EXAMPLE 8

The paper and paperboard substrates from Example 4 were used to determine what effect basis weight has on GM Fold. The average basis weight and GM Fold were calculated for the six samples calendered at different pressures. The resulting data is set forth in Table XIV and plotted in FIG. 25.

TABLE XIV

| | Average | Average |
|---|---|---|
| | Basis | Geometric |
| % Expandable | Weight, | Mean Fold, |
| microspheres | lb/3000 ft2 | MIT Double |
| 0 | 92 | 347 |
| 0 | 101 | 391 |
| 0 | 121 | 413 |
| 1 | 92 | 422 |
| 1 | 103 | 465 |
| 1 | 121 | 597 |

The data clearly shows that paper and paperboard with expandable microspheres has a higher GM Fold at any given basis weight. The data surprisingly shows that the difference in GM Fold between paper and paperboard with expandable microspheres and paper and paperboard without microspheres is greater as basis weight increases. This was an unexpected result and reveals that to achieve the greatest difference in GM Fold the basis weight should be 100 lb/3000 ft² or greater.

Having now described various aspects of the invention and preferred embodiments thereof, it will be recognized by those of ordinary skill that numerous modifications, variations and substitutions may exist within the spirit and scope of the appended claims.

1-36. (canceled)

37. A paper material for use in the manufacture of paper articles, comprising a web of cellulosic fibers and from about 0.1 to about 6 wt % based upon a total weight of the web on a dry basis of expanded microspheres, the paper web having a density equal to or greater than 7.5 lb/3000 ft²/mil; a caliper after calendaring of from about 3 mils to about 25 mils.

38. The paper material according to claim 37, wherein the paper web has a density of from about 6.0 lb/3000 ft²/mil to about 13.0 lb 3000 ft²/mil.

39. The paper material according to claim 37, wherein the paper web has a caliper after calendaring of from about 3.0 to about 14.0 mils.

40. The paper material according to claim 37, comprising from about 0.25 to about 5.0 wt. % based upon a total weight of the web on a dry basis of expanded micro spheres.

41. The paper material according to claim 37, comprising from 0.5 to about 3.0 wt. % based upon a total weight of the web on a dry basis of expanded microspheres.

42. The paper material according to claim 37, wherein the expanded microspheres in the paper web comprises synthetic polymeric microspheres.

43. The paper material according to claim 37, wherein the paper web has a basis weight of from about 20 lb/3000 ft² to about 300 lb/3000 ft².

44. The paper material according to claim 37, wherein the paper web has a basis weight of from about 20 lb/3000 ft² to about 200 lb/3000 ft².

45. The paper material according to claim 37, wherein the paper web has a basis weight of from about 28 lb/3000 ft² to about 180 lb/3000 ft².

46. The paper material according to claim 37, wherein the expanded microspheres in the paper web comprise microspheres made from at least one polymeric material selected from the group consisting of methyl methacrylate, ortho-chlorostyrene, polyortho-chlorostyrene, polyvinylbenzyl chloride, acrylonitrile, vinylidene chloride, para-tert-butyl styrene, vinyl acetate, butyl acrylate, styrene, methacrylic acid, and vinylbenzyl chloride.

47. The paper material according to claim 37, wherein the fibers in the paper web comprise from about 30 to about 100% by weight dry basis softwood fibers, from about 70 to about 0% by weight dry basis hardwood fibers and 0 to about 50% by weight dry basis post consumer waste.

48. The paper material according to claim 37, wherein the microspheres have an expanded diameter of up to about 60 microns.

49. The paper material according to claim 37, wherein the web has been calendered in a calendaring apparatus having one or more nips where the pressure at any nip is not more than about 350 lbs/lineal inch.

50. The paper material according to claim 49, wherein said pressure is equal to or less than about 280 lbs/lineal inch.

51. The paper material according to claim 49, wherein said pressure is equal to or less than about 250 lbs/lineal inch.

52. The paper material according to claim 49, wherein said pressure is equal to or less than about 100 lbs/lineal inch.

53. The paper material according to claim 49, wherein said pressure is equal to or less than about 50 lbs/lineal inch.

54. The paper material according to claim 37, wherein the paper material comprises at least one reverse die cut edge.

55. The paper material according to claim 37, wherein the paper material comprises at least one reverse die cut edge which exhibits an improved resistance to inflicting cuts upon human skin than does a paper material that is the same except that it does not contain expanded microspheres and does not have a density at least 7.5 lb/3000 ft2/mil.

56. The paper material according to claim 55, wherein the paper material exhibits a Cutting Index of less than about 40 when analyzed according to the Cutting Index 30 test.

57. The paper material according to claim 37, wherein the paper material exhibits a Cutting Index of less than about 40 when analyzed according to the Cutting Index 30 test.

58. The paper material of claim 37, wherein the paper material exhibits a GM Fold equal to or great than about 200.

59. The paper material according to claim 58, wherein the GM Fold is equal to or greater than about 350.

60. The paper material according to claim 58, wherein the GM Fold is equal to or greater than about 450.

61. The paper material according to claim 37, wherein said paper material exhibits a higher GM Fold than does a paper material that is the same except that it does not contain from about 0.1 to about 6 wt % based upon a total weight of the web on a dry basis expanded microspheres and does not have a density at least 7.5 lb/3000 ft²/mil.

62. The paper material according to claim 37, wherein said paper material exhibits a GM Fold substantially the same as that exhibited by a second paper material which is substantially the same as said paper material except it does not contain from about 0.1 to about 6 wt % based upon a total weight of the web on a dry basis expanded microspheres and has a basis weight that is 5% greater than the basis weight of said paper material.

63. A method for making the paper material according to claim 37, comprising
providing a papermaking furnish containing cellulosic fibers and from about 0.1 to about 6 wt % by weight dry basis expanded or expandable microspheres;
forming a fibrous web from the papermaking furnish;
drying the web; and
calendering the web to a caliper of from about 3 to about 25 mils and a density equal to or greater than 7.5 lb/3000 ft²/mil.

64. An article of manufacture having a body formed from the paper material according to claim 37.

65. The article according to claim 64, wherein said body comprises a substantially planar first portion and a substantially planar second portion, said first portion and second portion connect along a fold line and are capable of flexing along said line.

66. The paper material according to claim 37, wherein the paper web has a basis weight that is equal to or greater than about 90 lb/3000 ft².

67. The paper material according to claim 37, wherein the paper web has a basis weight of from about 90 lb/3000 ft² to about 300 lb/3000 ft².

68. The paper material according to claim 37, wherein the paper web has a basis weight of from about 100 lb/3000 ft² to about 300 lb/3000 ft².

69. The paper material according to claim 37, wherein said paper web has a caliper after calendaring of from about 7 to about 18 mils.

70. The paper material according to claim 37, wherein said paper web has a caliper after calendaring of from about 8 to about 14 mils.

71. The paper material according to claim 37, wherein said paper web has a caliper after calendaring of from about 9 to about 12 mils.

72. The paper material according to claim 37, wherein said paper web has a caliper after calendaring of from about 10 to about 11.5 mils.
